(19) United States
(12) Patent Application Publication
(10) Pub. No.: US 2017/0308878 A1
(43) Pub. Date: Oct. 26, 2017

(54) MOBILE PAYMENT SYSTEM WITH CONNECTED DEVICE AND MOBILE PAYMENT METHOD

(71) Applicant: INTERNATIONAL GAMES SYSTEM CO., LTD., New Taipei City (TW)

(72) Inventors: Jia-Wei YANG, New Taipei City (TW); Sheng-Lun LIN, New Taipei City (TW)

(21) Appl. No.: 15/232,821

(22) Filed: Aug. 10, 2016

(30) Foreign Application Priority Data
Apr. 25, 2016 (CN) 201610260787.4

(51) Int. Cl. G06Q 20/12; G06Q 30/06

(52) U.S. Cl. CPC G06Q 20/123; G06Q 30/0643

(57) ABSTRACT

The present disclosure provides a mobile payment system and a mobile payment method. The mobile, payment system includes an e-commerce platform, a connected device and a mobile device. The connected device has a display, the display is configured to show a multimedia content, the multimedia content includes at least a predetermined pattern, and the predetermined pattern corresponds to a virtual goods. The mobile device has an image-capturing device, and the image-capturing device is configured to capture the predetermined pattern from the display, such that the mobile device can obtain buying information on the virtual goods based on the predetermined pattern, so as to process an instant online transaction of the virtual goods through the e-commerce platform.

### RELATED APPLICATION LIGATIONS

This application claims priority to Chinese Application Serial Number 201610260787.4, filed Apr. 25, 2016, which is herein incorporated by reference.

### BACKGROUND

### Field of Invention

The present invention relates to E-commerce. More particularly the present invention relates to mobile payment systems and mobile payment methods.

### Description of Related Art

Nowadays, media content is displayed in many places and often provides information on goods for consumers.

If the consumer wants to buy the goods, in a conventional method he or she could search keywords through Internet, make a phone call, or find a physical store. The consumer must waste time to look for the goods before the consumer can buy the goods. However, as a result of the conventional method, the consumer may spend a lot of time and spirit to make purchase, or the consumer cannot find the goods and miss opportunities of this consumption.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

According to embodiments of the present disclosure, the present disclosure provides a mobile payment system and a mobile payment method to solve or circumvent aforesaid problems and disadvantages.

In one aspect, the mobile payment system includes an e-commerce platform, a connected device and a mobile device. The connected device has a display, the display is configured to show a multimedia content, the multimedia content includes at least a predetermined pattern, and the predetermined pattern corresponds to a virtual goods. The mobile device has an image-capturing device, and the image-capturing device is configured to capture the predetermined pattern from the display, such that the mobile device can obtain buying information on the virtual goods based on the predetermined pattern, so as to process an instant online transaction of the virtual goods through the e-commerce platform.

In one embodiment, the connected device is communicated with the e-commerce platform, the e-commerce platform synchronizes a result of the instant online transaction to the connected device, and the display of the connected device renders information related to the instant online transaction of the virtual goods in the multimedia content.

In one embodiment, the connected device is a game machine, and the multimedia content is a game content, wherein during the game machine performs the game content, the game machine instantly renders the virtual goods in the game content when the instant online transaction of the virtual goods is completed.

In one embodiment, the e-commerce platform includes a third party payment platform and a trading platform, the mobile device sends consumer information and trade confirmation associated with the virtual goods to the third party payment platform for performing the instant online transaction, the third party payment platform sends a result of the instant online transaction to the mobile device and the trading platform, and the trading platform synchronizes the result of the instant online transaction to the connected device.

In one embodiment, the e-commerce platform includes a third party payment platform and a trading platform, the mobile device sends consumer information and trade confirmation associated with the virtual goods to the trading platform, the trading platform sends the consumer information to the third party payment platform for performing the instant online transaction, the third party payment platform sends a result of the instant online transaction to the mobile device and the trading platform, and the trading platform synchronizes the result of the instant online transaction to the connected device.

In another aspect, a mobile payment method includes steps of using a display of a connected device to show a multimedia content, the multimedia content comprising at least a predetermined pattern, and the predetermined pattern corresponding to a virtual goods; using a image-capturing device of a mobile device to capture the predetermined pattern from the display, such that the mobile device obtains buying information of the virtual goods based on the predetermined pattern, so as to process an instant online transaction of the virtual goods through an e-commerce platform.

In one embodiment, the connected device is communicated with the e-commerce platform, the e-commerce platform synchronizes a result of the instant online transaction to the connected device, the display of the connected device renders information related to the instant online transaction of the virtual goods in the multimedia content.

In one embodiment, the connected device is a game machine and the multimedia content is a game content, wherein during the game machine performs the game content, the game machine instantly renders the virtual goods in the game content when the instant online transaction of the virtual goods is completed.

In one embodiment, the e-commerce platform includes a third party payment platform and a trading platforms, the mobile device sends consumer information and trade confirmation associated with the virtual goods to the third party payment platform for performing the instant online transaction, the third party payment platform sends a result of the instant online transaction to the mobile device and the trading platform, and the trading platform synchronizes the result of the instant online transaction to the connected device.

In one embodiment, the e-commerce platform includes a third party payment platform and a trading platform, the mobile device sends consumer information and trade confirmation associated with the virtual goods to the trading platform, the trading platform sends the consumer information to the third party payment platform for performing the instant online transaction, the third party payment platform sends a result of the instant online transaction to the mobile device and the trading platform, and the trading platform synchronizes the result of the instant online transaction to the connected device.

In view of the foregoing, the present disclosure converts information related to the consumption into a mobile device readable content and establishes the platform for fast trading between the consumer and his or her trade partner, thereby simplifying the complexity of consumer behavior.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a block diagram of a mobile payment system according to one embodiment of the present disclosure; and

FIG. 2 is a flow chart of a mobile payment method according to one embodiment of the present disclosure.

### DETAILED DESCRIPTION

In the following detailed description, for purposes of explanation, numerous specific details are set forth in order to attain a thorough understanding of the disclosed embodiments. In accordance with common practice, like reference numerals and designations in the various drawings are used to indicate like elements/parts. Moreover, well-known elements or method steps are schematically shown or omitted in order to simplify the drawing and to avoid unnecessary limitation to the claimed invention.

In the detailed embodiment and the claims, unless otherwise indicated, the article “a” or “the” refers to one or more than one>of the word modified by the article a or “the.”

Through the present specification and the annexed claims, the description involving the “electrical connection” refers to the cases where one component is electrically connected to another component indirectly via other component(s), or one component is electrically connected to another component directly without any other component.

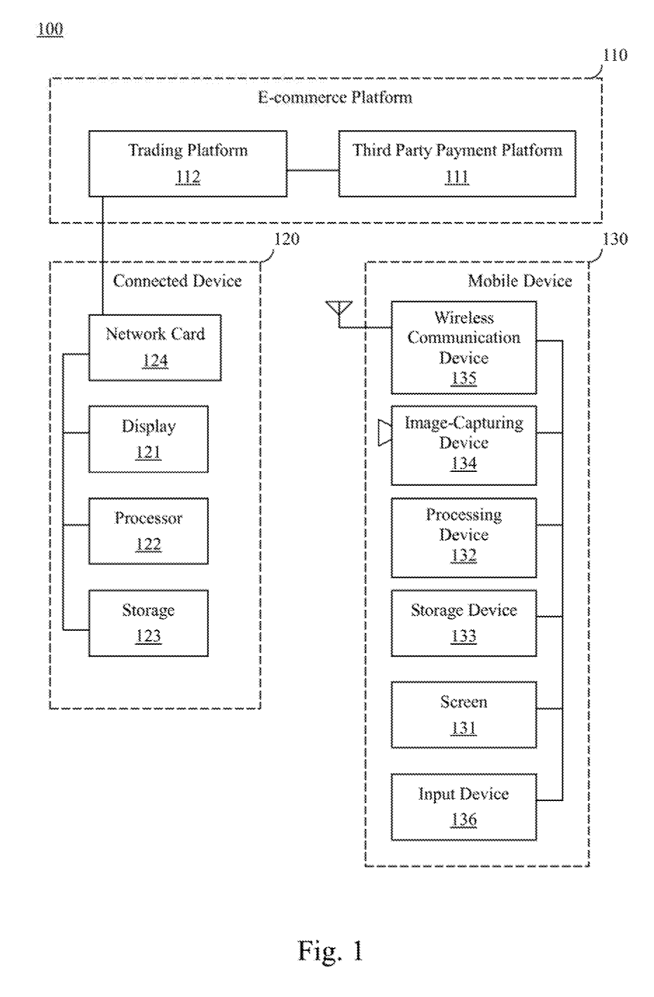

FIG. 1 is a block diagram of a mobile payment system 100 according to one embodiment of the present disclosure. As illustrated in FIG. 1, the system 100 includes an e-commerce platform 110, a connected device 120 and a mobile device 130. The connected device 120 is communicated with the e-commerce platform 110. The mobile device 130 is wirelessly communicated with the e-commerce platform 110 through a wireless network.

In FIG. 1, the connected device 120 has a display 121, a processor 122, storage 123 and a network card 124. Structurally, the processor 122 is electrically connected to the display 121, the storage 123 and the network card 124. For instance, the connected device 120 may be a television, a digital advertising wall, a digital or electronic signage, a coin-operated entertainment machine (e.g., an arcade game) or other multimedia devices, in which the display 121 may be an liquid-crystal display (LCD), a cathode ray tube (CRT) display or other displays, the processor 122 may be a central processing unit (CPU) or the like, the storage 123 may be a hard disk, a flash memory or other storage media, and the network card 124 is electrically connected to the e-commerce platform 110.

In FIG. 1, the mobile device 130 has a screen 131, a processing device 132, a storage device 133, an image-capturing device 134 (e.g., a camera module), the wireless communication device 135 and the input device 136. Structurally, the processing device 132 is electrically connected to the screen 131, the storage device 133, the image-capturing device 134, the wireless communication device 135 and the input device 136. For instance, the mobile device 130 may be a smart phone, a tablet, a laptop, or other electronic products, in which the screen 131 may be a LCD screen, an electronic paper or other display screens, the processing device 132 may be a CPU, a micro controller unit (MCU) or the like, the storage device 133 may be a hard disk, a flash memory or other storage media, the image-capturing device 134 may be the camera module including, for example, lens, photosensitive elements and so forth, the wireless communication device 135 may be a 4G module, a Wi-Fi module and/or another wireless transceiver, the input device 136 may be a keyboard, a touch-pad, a trackball or the like. Additionally or alternatively, the input device 136 and the screen 131 can be integrated into a touch screen.

During the connected device 120 operates, the display 121 of the connected device 120 is configured to show multimedia content, the multimedia content includes at least a predetermined pattern, and the predetermined pattern corresponds to a virtual goods, so as to allow the consumer to choose the virtual goods. In one embodiment, the connected device 120 is a game machine, and the multimedia content is a game content. When the processor 122 executes a game program stored in the storage 123, so that the display 121 can show the game content in which the virtual goods ray be one ore more tradable virtual objects including, for example, roles, vehicles, props, gears, coins gems, and so forth. These virtual objects can be patterned as the predetermined patterns displayed in the game content.

If the consumer wants to buy the virtual goods, he or she can use the image-capturing device 131 of the mobile device 130 to capture the predetermined pattern from the display 121 of the connected device 120, such that the mobile device 130 can obtain buying information on the virtual goods based on the predetermined pattern, so as to use the wireless communication device 135 to communicate with the e-commerce platform 110 for processing an instant online transaction of the virtual goods.

Then, the e-commerce platform 110 synchronizes a result of the instant online transaction to the connected device 120, the display 121 of the connected device 120 renders information related to the instant online transaction of the virtual goods in the multimedia content. Moreover, the screen 131 of the mobile device 130 renders the result of the instant online transaction. In this way, double screen technique can be achieved to create a real-time interactive effect upon the display 121 and the screen 131.

In one embodiment, the connected device 120 is the game machine connected to network, and it supports multiplayer online battle or competition, and also supports barcode login. Specifically, before starting a game, the display 121 of the game machine displays a mobile barcode. The player uses the input device 136 of the mobile device 130 to select and open a corresponding game program and inputs an ID number and a password to log in, so that the processing device 132 execute the game program can be executed by to enable the mage-capturing device 134. The player can use the mage-capturing device 134 to scan the mobile barcode displayed by the display 121 of the game machine, and the wireless communication device 135 sends login information to the game machine through the network, so that the game machine can use the same ID number to log in the game. Then, the game machine performs the game, such as a racing game. During the racing game, if the player uses the game machine to control an ordinary sedan and his or her opponent drives a sports car, the player can use the mobile device 130 to shoot the sports car in the game content displayed by the game machine, and the instant online transaction of this virtual sports car is completed through the e-commerce platform 110, where the image of the sports car is above-mentioned predetermined pattern for example, but the present disclosure is not limited thereto. Then, the e-commerce platform 110 synchronizes the result of the instant online transaction to the game machine and the mobile device 130. During the racing game, the display 121 of the game machine renders the player's sports car in the game content, i.e., the player's ordinary sedan has been replaced with the sports car, so as to enhance the chances to win for the player. The screen 131 of the mobile device 130 renders the result of the instant online transaction, so as to allow the player to check, thereby improving the user experience of this cross-screen manner.

For a more complete understanding of the e-commerce platform 110, continue to refer FIG. 1, the e-commerce platform 110 includes a third party payment platform 111 and a trading platform 112, and the third party payment platform 111 and the trading platform 112 may be two respective computer servers. Structurally, the third party payment platform 111 is electrically connected, to the trading platform 112, and the trading platform 112 is electrically connected to the connected device 120. For example, the trading platform 112 is a game server owned by the game provider, and the third party payment platform 111 is a third party server providing third party payment services, such as Google play, Apple store or the like.

In one embodiment, after the mobile device 130 obtains the buying information on the virtual goods based on the predetermined pattern, if the consumer (e.g., the player) selects the virtual goods for purchase, the mobile device 130 sends consumer information (e.g., the ID number, the password, etc.) and trade confirmation associated with the virtual goods to the third party payment platform 111 for performing the instant online transaction, the third party payment platform 111 sends a result of the instant online transaction to the mobile device 130 and the trading platform 112, and the trading platform 112 synchronizes the result of the instant online transaction to the connected device 120.

In an alternative embodiment, after the mobile device 130 obtains the buying information on the virtual goods based on the predetermined pattern, if the consumer (e.g., the player) selects the virtual goods for purchase, the mobile device 130 sends consumer information (e.g., the ID number, the password, etc.) and trade confirmation associated with the virtual goods to the trading platform 112, the trading platform 112 sends the consumer information to the third party payment platform 111 for performing the instant online transaction, the third party payment platform 111 sends a result of the instant online transaction to the mobile device 130 and the trading platform 112, and the trading platform 112 synchronizes the result of the instant online transaction to the connected device 120.

Moreover, in one embodiment, the trading platform 112 can collect a plurality of online transactions and related consumer information, so as to perform a consumer segmentation analysis.

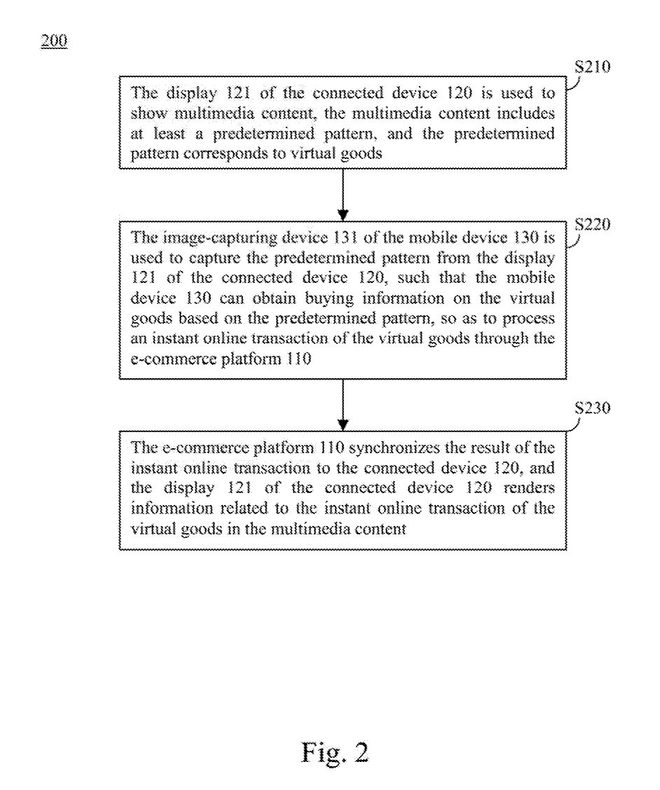

FIG. 2 is a flow chart of a mobile payment method 200 according to one embodiment of the present disclosure. As illustrated in FIG. 2, the mobile payment method 200 includes the operations S210, S220 and S230, However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently. With reference to FIGS. 1 and 2, some embodiments are explanted below.

In operation S210, the display 121 of the connected device 120 is used to show multimedia content, the multimedia content includes at least a predetermined pattern, and the predetermined pattern corresponds to virtual goods. In one embodiment, the connected device 120 is a game machine, and the multimedia content is a game content. When the processor 122 executes a game program stored in the storage 123, so that the display 121 can show the game content, in which the virtual goods may be one ore more tradable virtual objects including, for example, roles, vehicles, props, gears, coins, gems, and so forth. These virtual objects can be patterned as the predetermined patter ns displayed in the game content.

In operation S220, the image-capturing device 131 of the mobile device 130 is used to capture the predetermined pattern from the display 121 of the connected device 120, such that the mobile device 130 can obtain buying information on the virtual goods based on the predetermined pattern, so as to process an instant online transaction of the virtual goods through the e-commerce platform 110.

The e-commerce platform 110 as mentioned in operation S220 includes the third party payment platform 111 and the trading platform 112. In one embodiment, if the consumer (e.g., the player) selects the virtual goods corresponding to the predetermined pattern for purchase, in operation S220 the mobile device 130 sends consumer information (e.g., the ID number, the password, etc.) and trade confirmation associated with the virtual goods to the third party payment platform 111 for performing the instant online transaction, the third party payment platform 111 sends the result of the instant online transaction to the mobile device 130 and the trading platform 112.

In an alternative embodiment, if the consumer (e.g., the player) selects the virtual goods corresponding to the predetermined pattern for purchase, in operation S220 the mobile device 130 sends consumer information (e.g., the ID number, the password, etc.) and trade confirmation associated with the virtual goods to the trading platform 112, the trading platform 112 sends the consumer information to the third party payment platform 111 for performing the instant online transaction, the third party payment platform 111 sends the result of the instant online transaction to the mobile device 130 and the trading platform 112.

In operation S230, the trading platform 112 of the e-commerce platform 110 synchronizes the result of the instant online transaction to the connected device 120, and the display 121 of the connected device 120 renders information related to the instant online transaction of the virtual goods in the multimedia content. In one embodiment, the connected device 120 is the game machine, and the multimedia content is the game content. During the game machine performs the game content, when the instant online transaction of the virtual goods is completed, the game machine instantly renders the virtual goods (e.g., roles, vehicles, props, gears, coins, gems, or the like) in the game content.

In view of the foregoing, the present disclosure converts information related to the consumption into a mobile device readable content and establishes the platform for fast trading between the consumer and his or her trade partner, thereby simplifying the complexity of consumer behavior.

Although various embodiments of the invention have been described above with a certain degree of particularity, or with reference to one or more individual embodiments, they are not limiting to the scope of the present disclosure. Those with ordinary skill in the art could make numerous alterations to the disclosed embodiments without departing from the spirit or scope of this invention. Accordingly, the protection scope of the present disclosure shall be defined by the accompany claims.

What is claimed is:

1. A mobile payment system, comprising:
an e-commerce platform;
a connected device having a display, the display configured to show multimedia content, the multimedia content comprising at least a predetermined pattern, and the predetermined pattern corresponding to a virtual goods; and
a mobile device having a image-capturing device, the image-capturing device configured to capture the predetermined pattern from the display, such that the mobile device obtains buying information on the virtual goods based on the predetermined pattern, so as to process an instant online transaction of the virtual goods through the e-commerce platform.

2. The mobile payment system of claim 1, wherein the connected device communicated with the e-commerce platform, the e-commerce platform synchronizes a result of the instant online transaction to the connected device, the display of the connected device renders information related to the instant online transaction of the virtual goods in the multimedia content.

3. The mobile payment system of claim 2, wherein the connected device is a game machine, and the multimedia content is a game content, wherein during the game machine performs the game content, the game machine instantly renders the virtual goods in the game content when the instant online transaction of the virtual goods is completed.

4. The mobile payment system of claim 1, wherein the e-commerce platform comprises a third party payment platform and a trading platform, the mobile device sends consumer information and trade confirmation associated with the virtual goods to the third party payment platform for performing the instant online transaction, the third party payment platform sends a result of the instant online transaction to the mobile device and the trading platform, and the trading platform synchronizes the result of the instant online transaction to the connected device.

5. The mobile payment system of claim 1, wherein the e-commerce platform comprises a third party payment platform and a trading platform, the mobile device sends consumer information and trade confirmation associated with the virtual goods to the trading platform, the trading platform sends the consumer information to the third party payment platform for performing the instant online transaction, the third party payment platform sends a result of the instant online transaction to the mobile device and the trading platform, and the trading platform synchronizes the result of the instant online transaction to the connected device.

6. A mobile payment method, comprising:
using a display of a connected device to show a multimedia content, the multimedia content comprising at least a predetermined pattern, and the predetermined pattern corresponding to a virtual goods; and
using a image-capturing device of a mobile device to capture the predetermined pattern from the display, such that the mobile device obtains buying information on the virtual goods based on the predetermined pattern, so as to process an instant online transaction of the virtual goods through an e-commerce platform.

7. The mobile payment method of claim 6, wherein the connected device is communicated, with the e-commerce platform, the e-commerce platform synchronizes a result of the instant online transaction to the connected device, the display of the connected device renders information related to the instant online transaction of the virtual goods in the multimedia content.

8. The mobile payment method of claim 7, wherein the connected device is a game machine, and the multimedia content is a game content, wherein during the game machine performs the game content, the game machine instantly renders the virtual goods in the game content when the instant online transaction of the virtual goods is completed.

9. The mobile payment method of claim 6, wherein the e-commerce platform comprises a third party payment platform and a trading platform, the mobile device sends consumer information and trade confirmation associated with the virtual goods to the third party payment platform for performing the instant online transaction, the third party payment platform sends a result of the instant online transaction to the mobile device and the trading platform, and the trading platform synchronizes the result of the instant online transaction to the connected device.

10. The mobile payment method of claim 6, wherein the e-commerce platform comprises a third party payment platform and a trading platform, the mobile device sends consumer information and trade confirmation associated with the virtual goods to the trading platform, the trading platform sends the consumer information to the third party payment platform for performing the instant online transaction, the third party payment platform sends a result of the instant online transaction to the mobile device and the trading platform, and the trading platform synchronizes the result of the instant online transaction to the connected device.
